(19) United States
(12) Patent Application Publication
(10) Pub. No.: US 2026/0149819 A1
(43) Pub. Date: May 28, 2026

(54) ENCODING DEVICE, DECODING DEVICE, AND OPERATING METHOD THEREOF

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Sungyong LEE, Suwon-si (KR); Kyunghan LEE, Suwon-si (KR); Huijeong CHOE, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/203,897

(22) Filed: May 9, 2025

(30) Foreign Application Priority Data
Nov. 27, 2024 (KR) 10-2024-0172489

(51) Int. Cl. H04N 19/30; H04N 19/146; H04N 19/164

(52) U.S. Cl. CPC H04N 19/30; H04N 19/146; H04N 19/164

(57) ABSTRACT

A method of encoding data includes receiving data, determining a compression level of the data, encoding the data by an encoding layer corresponding to the determined compression level, among a plurality of encoding layers, and outputting the encoded data.

### CROSS-REFERENCE TO RELATED APPLICATION

This application is based on and claims priority from Korean Patent Application No. 10-2024-0172489, filed on Nov. 27, 2024, in the Korean Intellectual Property Office, the disclosure of which is incorporated by reference herein in its entirety.

### BACKGROUND

### 1. Field

Methods and devices consistent with embodiments relate to an encoding device, a decoding device, and an operating method thereof.

### 2. Description of the Related Art

Recently, data compression and restoration technology based on a deep neural network (DNN) utilizing deep learning technology is gradually used. DNN-based codecs may effectively encode complex patterns of input data and achieve high compression ratios by utilizing models trained through large-scale data sets. The DNN-based codecs may compress high-resolution images or video data while minimizing quality degradation and may provide high performance in large-scale data transmission.

The data compression and restoration technology based on a DNN focuses on a method of compressing data to a fixed size and encoding and decoding the data. In order to achieve the highest possible compression ratio, a method of extracting only essential information for a corresponding application is proposed based on application requirements received from a server, or a method of enhancing image quality utilizing super-resolution techniques using data compressed to a very small level is proposed based on computation capability of a powerful server.

In another technique, a method data compression and restoration focuses on compressing data to a small size and then improving data quality by using computation capability of a server. However, the amount of operations required to achieve a high compression ratio is large, which may cause delay time in real-time processing.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a data encoding method including: receiving data; determining a compression level corresponding to the data; obtaining encoded data by encoding the data by an encoding layer corresponding to the determined compression level, among a plurality of encoding layers; and outputting the encoded data.

The determining of the compression level of the data may include at least one of: determining the compression level based on a requirement of a target application of the data; determining the compression level based on a communication environment of the data; or determining the compression level based on a size of the data.

The encoding the data may include, based on the determined compression level being a first compression level, encoding the data by a first encoding layer, among the plurality of encoding layers, corresponding to the first compression level.

The encoding the data may include: based on the determined compression level being a second compression level: encoding the data by a first encoding layer corresponding to a first compression level; and sequentially encoding output data of the first encoding layer by a second encoding layer corresponding to the second compression level.

The encoding the data may include extracting a feature map from the data by a convolution layer.

Each of the plurality of encoding layers may be trained to output a result for a target service in a decoding layer configured to decode the encoded data.

A first encoding layer corresponding to a first compression operation among the plurality of encoding layers and a first decoding layer corresponding to the first encoding layer may be trained to obtain the result for the target service based on a first loss function.

A second encoding layer corresponding to a second compression operation among the plurality of encoding layers and a second decoding layer corresponding to the second encoding layer may be trained to obtain the result for the target service based on a second loss function that fixes weights of the first encoding layer and the first decoding layer.

According to another aspect of the disclosure, there is provided a data decoding method including: receiving data; receiving a compression level of the data; obtaining decoded data by decoding the data by a decoding layer corresponding to the compression level, among a plurality of decoding layers; and outputting the decoded data.

The compression level of the data may be dynamically determined based on at least one of: requirements of a target application of the data; a communication environment of the data; or a size of the data.

The decoding of the data may include, based on the compression level being a first compression level, decoding the data by a first decoding layer, among the plurality of decoding layers, corresponding to the first compression level.

The decoding the data may include: based on the compression level being a second compression level: decoding the data by a second decoding layer corresponding to the second compression level; and sequentially decoding output data of the second decoding layer by a first decoding layer corresponding to a first compression level.

The decoded data may be a result for a target service corresponding to the data.

Each of the plurality of decoding layers may be trained to output a result for a target service.

A first decoding layer corresponding to a first compression operation among the plurality of decoding layers and a first encoding layer corresponding to the first decoding layer may be trained to obtain the result for the target service based on a first loss function, and a second decoding layer corresponding to a second compression operation among the plurality of decoding layers and a second encoding layer corresponding to the second decoding layer may be trained to obtain the result for the target service based on a second loss function that fixes weights of the first encoding layer and the first decoding layer.

According to another aspect of the disclosure, there is provided an encoding device including: at least one processor; and a memory configured to store instructions, wherein, when executed by the at least one processor, the instructions are configured to cause the encoding device to: receive data; determine a compression level corresponding to the data; obtain encoded data by encoding the data by an encoding layer corresponding to the compression level, among a plurality of encoding layers; and output the encoded data.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a diagram illustrating a structure for adjusting a compression ratio in proportion to an encoding time, according to an embodiment;

FIG. 2 is a flowchart illustrating an operation method of an encoding device, according to an embodiment;

FIG. 3 is a flowchart illustrating an operation method of a decoding device, according to an embodiment;

FIG. 4 is a diagram illustrating a structure of an encoding device and a decoding device, according to an embodiment;

FIG. 5 is a diagram illustrating an operation of dynamically determining a compression level based on a wireless channel condition, according to an embodiment;

FIG. 6 is a diagram illustrating an operation of determining a compression level based on wireless channel condition estimation, according to an embodiment;

FIG. 7 is a diagram illustrating an operation of an encoding device according to a fluctuation in a channel condition, according to an embodiment;

FIG. 8 is a diagram illustrating an encoding device having various layer structures, according to an embodiment;

FIG. 9 is a block diagram illustrating a node of an encoding device, according to an embodiment; and

FIG. 10 is a diagram illustrating an example of a system according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless otherwise mentioned, the descriptions on the embodiments may be applicable to the following embodiments and thus, duplicated descriptions will be omitted for conciseness.

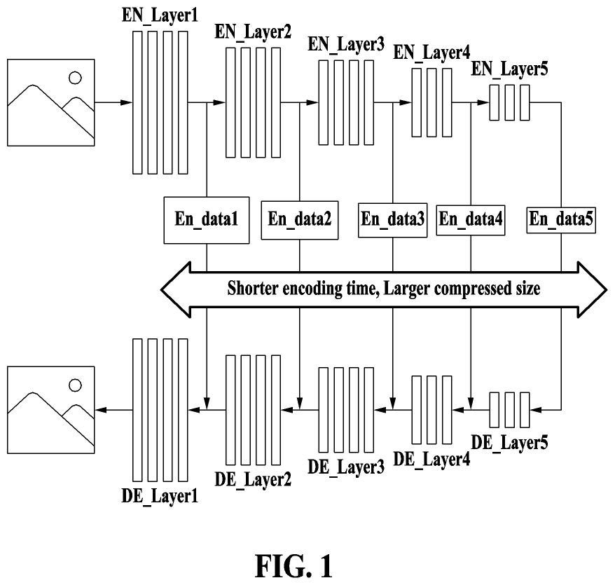

FIG. 1 is a diagram illustrating a structure for adjusting a compression ratio in proportion to an encoding time, according to an embodiment.

An encoding and decoding process in a general deep neural network (DNN)—based data encoding and decoding technique may operate in an end-to-end method from the starting point of an encoding device to the end point of a decoding device, and thus, a compression ratio and operation time may be fixed. Therefore, it may be difficult to dynamically respond to a target application or wireless channel conditions of data. Moreover, it may be difficult to adjust the amount of operations considering the compression ratio and compression time.

For example, the structure illustrated in FIG. 1 is based on a feature pyramid network (FPN) structure. The FPN is a neural network that generates feature maps of different resolutions to recognize objects of various sizes and integrates the feature maps to detect objects.

Referring to FIG. 1, when passing through a first encoding layer (EN_Layer1), data may be encoded at a first compression level, and in order to decode the encoded data (En_data1), the data may be passed through a first decoding layer (DE_Layer1) corresponding to the first encoding layer. The first compression level may correspond to a low compression ratio. According to an embodiment, an amount of operations may be proportional to the number of layers through which the data passes, and the compression ratio may have an inverse relationship.

For example, in order to encode the data by a second compression level with a lower compression ratio than the first compression level, the data may be encoded at the lower compression ratio of a first level through the first encoding layer (EN_Layer1) and then encoded at the second compression level through a second encoding layer (EN_Layer2). The second compression level may have a higher compression ratio than the first compression level. In addition, in order to decode the data encoded through the first encoding layer and the second encoding layer, the encoded data (En_data2) may be passed through a second decoding layer (DE_Layer2) corresponding to the second encoding layer (EN_Layer2) and then sequentially passed through the first decoding layer (DE_Layer1) corresponding to the first encoding layer (EN_Layer1). Similarly, the amount of operations may be proportional to the number of layers through which the data passes, and the compression ratio may have an inverse relationship.

As described above, an encoding device and a decoding device having a plurality of compression levels may be provided. For example, as illustrated in FIG. 1, five compression levels may be provided. For example, the first compression level may include the first encoding layer (EN_Layer1) and the first decoding layer (DE_Layer1), the second compression level may include the second encoding layer (EN_Layer2) and the second decoding layer (DE_Layer2), the third compression level may include a third encoding layer (EN_Layer3) and a third decoding layer (DE_Layer3), the fourth compression level may include a fourth encoding layer (EN_Layer4) and a fourth decoding layer (DE_Layer4), and the fifth compression level may include a fifth encoding layer (EN_Layer5) and a fifth decoding layer (DE_Layer5). The first encoding layer (EN_Layer1) may output first encoded data (En_data1), the second encoding layer (EN_Layer2) may output second encoded data (En_data2), a third encoding layer (EN_Layer3) may output third encoded data (En_data3), a fourth encoding layer (EN_Layer4) may output fourth encoded data (En_data4), and a fifth encoding layer (EN_Layer5) may output fifth encoded data (En_data4). However, the disclosure is not limited thereto, and as such, according to another embodiment, more than five compression levels may also be provided. The encoding device and the decoding device may be implemented as a single encoding device and a single decoding device, respectively. According to an embodiment, depending on the type of DNN used as the encoding device and an application, more diverse compression levels and compression points may be designed.

According to an embodiment, based on the structure illustrated in FIG. 1, feature maps of different resolutions may be used to determine the compression level and the compression time at runtime. To this end, the number of layers to be used may be determined based on the time allocated for encoding.

According to an embodiment, each layer may have a predefined time cost, and an encoding process may have a compression level selected such that total allowed time is not exceeded.

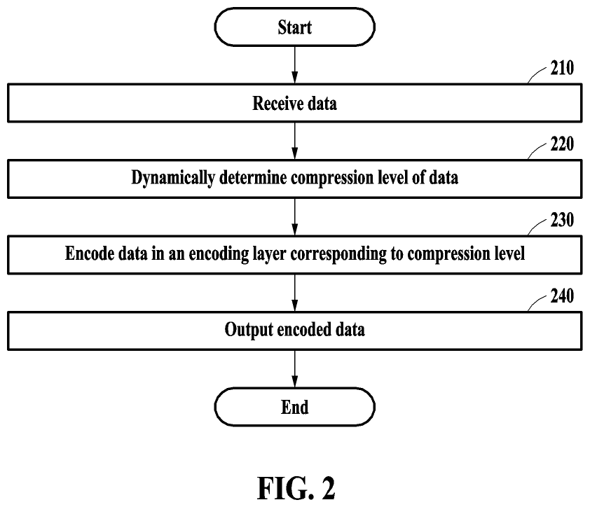

FIG. 2 is a flowchart illustrating an operation method of an encoding device, according to an embodiment.

In operation 210, the method may include receiving data. For example, the encoding device may receive the data.

The data may include, but is not limited to, images or videos. For example, the data may include images or videos captured by a user terminal or data stored in a user terminal.

In operation 220, the method may include dynamically determining a compression level of the data. For example, the encoding device may dynamically determine a compression level of the data.

For example, the encoding device may encode data to transmit the data to a device such as a server and may dynamically determine the compression level of the data based on requirements of an application that is to receive the data. In an example case in which only a small amount of information of the data is required in the application, a compression level with a high compression ratio may be determined.

In another example, the encoding device may determine the compression level based on a communication environment in which the data is transmitted to the server. In an example case in which uplink wireless channel conditions are estimated and the channel conditions are relatively good so that large data with a low compression ratio may be smoothly transmitted, a compression level with a low compression ratio may be determined.

According to an embodiment, the compression level may be determined based on the size of the data. The compression level of the data may be determined as the compression level corresponding to the size of the data, based on at least one predetermined standard.

In operation 230, the method may include encoding the data in an encoding layer corresponding to the determined compression level, among one or more encoding layers. For example, the encoding device may encode the data sequentially from a first encoding layer up to the encoding layer corresponding to the determined compression level.

In an example case in which the determined compression level is a first compression level, the data may be encoded using one first encoding layer for the first compression level. In an example case in which the determined compression level is a second compression level, the data may be encoded using the first encoding layer and a second encoding layer for the second compression level, the second encoding layer being connected to the first encoding layer. In this case, the second encoding layer is a layer subsequent to the first encoding layer, among the plurality of encoding layers. In an example case in which the determined compression level is a third compression level, the data may be encoded through the first encoding layer, the second encoding layer, and a third encoding layer for a third compression level, the third encoding layer being connected to the first encoding layer. In this case, the third encoding layer is a layer subsequent to the second encoding layer, the second encoding layer is a layer subsequent to the first encoding layer, among the plurality of encoding layers.

In an example case in which the compression level is three or higher, the data may be encoded through all encoding layers connected to an encoding layer for a corresponding compression level.

The compression level may be defined as that the compression ratio increases as the compression level increases. For example, the first compression level may represent the lowest compression ratio (least compressed) and the second compression level may represent the next lowest compression ratio.

In operation 240, the method may include outputting the encoded data. For example, the encoding device may output the encoded data.

For example, the encoding device may transmit the encoded data to a server via a communication interface connected to the encoding device.

The data transmitted to the server may obtain a result in a form suitable for a target service provided by decoding the data by the server. Hereinafter, an operation method of the decoding device is described.

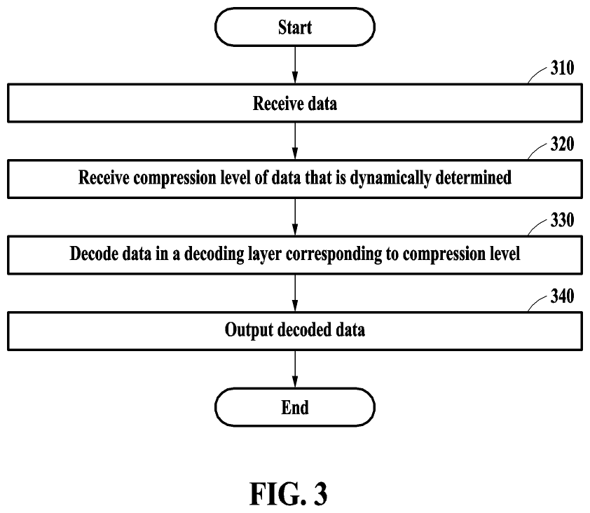

FIG. 3 is a flowchart illustrating an operation method of a decoding device, according to an embodiment.

In operation 310, the method may include receiving data. For example, the decoding device may receive data.

The decoding device may obtain the data received via a communication device. The data may correspond to data that is encoded and transmitted from a terminal.

In operation 320, the method may include receiving compression level of data. For example, the decoding device may receive a compression level of data. For example, the compression level of data may be dynamically determined.

The decoding device may receive information about the compression level of the data when receiving the data. For example, the decoding device may receive information about the compression level of the data along with data. In another example, the information about the compression level of the data may be received separately from the data.

According to an embodiment, the compression level of the data may be dynamically determined based on requirements of an application on a server. In an example case in which only a small amount of information of the data is required in the application, a compression level with a high compression ratio may be determined. In another example, the compression level may be determined based on a communication environment in which the data is transmitted. In an example case in which uplink wireless channel conditions are estimated and the channel conditions are relatively good so that large data with a low compression ratio may be smoothly transmitted, a compression level with a low compression ratio may be determined. According to another embodiment, the compression level may be determined based on the size of the data. The compression level of the data may be determined with the size of the data corresponding to the compression level, based on at least one predetermined standard.

In operation 330, the method may include decoding the in a decoding layer corresponding to the compression level, among one or more decoding layers. For example, the decoding device may decode the data sequentially from a decoding layer corresponding to the compression level to a first layer, among the one or more decoding layers.

An encoding device may encode the data sequentially according to the compression level, and the decoding device may decode the encoded data.

In an example case in which a confirmed compression level is a first compression level, the data may be decoded using a single first decoding layer for the first compression level. In an example case in which the compression level is a second compression level, the data may be decoded through a second encoding device layer and then decoded using the first decoding layer connected to a second encoding device. In an example case in which the compression level is a third compression level, the data may be decoded by sequentially passing through a third encoding layer, a second encoding layer, and a first encoding layer connected to the second encoding layer.

According to an embodiment, the data may be decoded through a single pretrained decoding layer regardless of the compression level of the encoded data. The decoding layer may be trained corresponding to the first compression level of the encoding layer, and the data decoded from the pretrained decoding layer may show a result within the same error regardless of the compression level of the encoded data.

In operation 340, the method may include outputting the decoded data. For example, the decoding device may output the decoded data.

The decoded data may be output in a form suitable for target services of a target application for applying the data received from a device that has obtained the data, such as a server.

For example, the data may be decoded to obtain results suitable for the target services such as classification and segmentation using the decoded data in the target application.

The training of the encoding device and the decoding device is described in detail below.

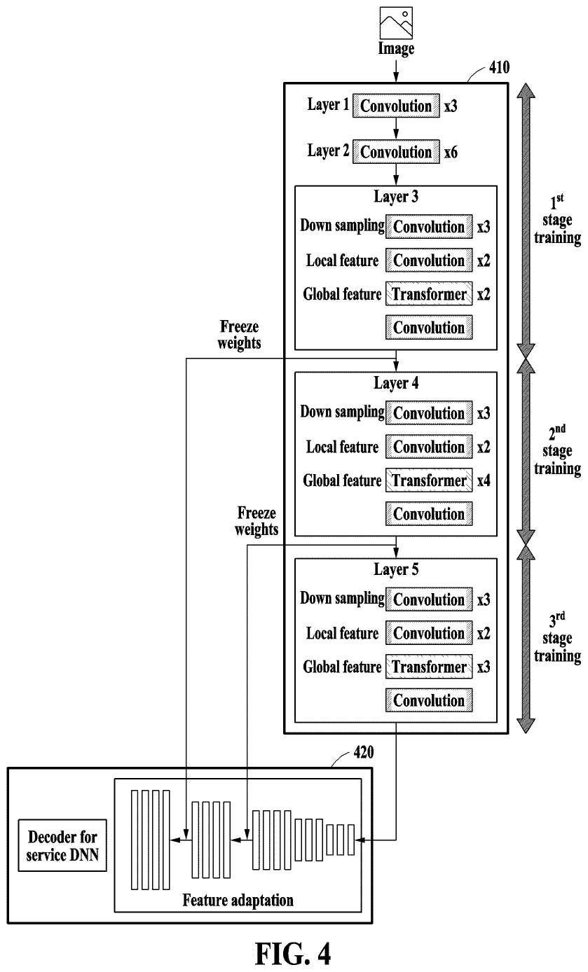

FIG. 4 is a diagram illustrating a structure of an encoding device 410 and a decoding device 420, according to an embodiment.

Unlike general DNN-based data encoding and decoding technologies, an encoding device 410 may be configured as a single encoding device with a plurality of trained encoding layers, and a decoding device 420 may be configured with a plurality of decoding layers corresponding to the encoding layers included in the encoding device 410. The decoding layers may be configured as a single decoding layer. In an example case in which the decoding layer is implemented as one layer, the layer may be configured as a decoding layer corresponding to a layer 3 of the encoding device 410.

The encoding device 410 may dynamically adjust the amount of operations and a compression ratio. For example, data may be encoded using at least one of the layer 3, a layer 4, and a layer 5 of the encoding device 410, and encoding may be performed sequentially through each encoding layer among a plurality of encoding layers. For example, for the highest compression ratio provided by the encoding device 410, all operations of the layer 3 to the layer 5 may be passed, and conversely, for the lowest compression ratio, only operations of the layer 3 may be passed.

A layer 1 and a layer 2 of the encoding device 410 may be adaption modules and may reconstruct feature maps of various resolutions generated by the encoding device 410 into a form that may be used in a target application so that the decoding device 420 may accept the feature maps. For example, the layer 1 and the layer 2 may reconstruct the data that is input to obtain results suitable for target services such as classification and segmentation in the target application.

The encoding device 410 may perform sequential training of a plurality of encoding layers according to the compression operation. In the first compression operation, the data may be encoded at a set lowest compression ratio, in the second compression operation, the data may be encoded at a higher compression ratio than the first compression operation, and in the third compression operation, the data may be encoded at a higher compression ratio than the second compression operation. By adding layers, compression ratios that are higher than those of the third compression operation may be provided.

The compression ratio at each operation may be determined during training. For example, the compression ratio for the first compression operation may be determined as 10 percent (%), the compression ratio for the second compression operation as 30%, the compression ratio for the third compression operation as 50%, and the compression ratio of each encoding layer may be determined through training of the corresponding compression ratios.

The layer 3 and the decoding layer corresponding to the layer 3 may be trained to encode and decode the data at the compression ratio according to the first compression operation in the encoding device 410 and the decoding device 420. Here, the layer 1 and the layer 2 may be trained together. During the training, a loss function may be used considering the target services, for example, cross entropy may be considered. The training of the layer 1, the layer 2 and the layer 3 may be referred to as first stage training.

The loss function for the training may be set as shown in Equation 1 below.

$$\begin{matrix}{ℒ}_{low} = {ℒ}_{CE} ( y , {\hat{y}}_{low} ; {θ}_{low} ) \\ {ℒ}_{mid} = {ℒ}_{CE} ( y , {\hat{y}}_{mid} ; {\overline{θ}}_{low} , {θ}_{mid} ) \\ {ℒ}_{high} = {ℒ}_{CE} ( y , {\hat{y}}_{high} ; {\overline{θ}}_{low} , {\overline{θ}}_{mid} , {θ}_{high} )\end{matrix} \qquad [ Equation 1 ]$$

Here, L_low denotes a loss function of a layer with a low compression ratio, L_mid denotes a loss function of a layer for the second compression operation, and L_high denotes a loss function of a layer for the third compression operation. For example, the layer with the low compression ratio may be a layer for the first compression operation. As illustrated above, considering the cross entropy, y denotes an output of a layer, ŷ denotes ground truth of the output, 0 denotes a weight of the corresponding layer, and @ denotes a fixed weight of the corresponding layer.

The layer 4 may be trained to encode the data at the compression ratio according to the second compression operation in the encoding device 410. Here, the layer 4 may be trained to implement a predetermined compression ratio by fixing weights pretrained in the layers 1 to 3 and using a loss function that follows a training distribution of the layer 3. The training of the layer 4 may be referred to as second stage training.

Similarly, the layer 5 may be trained to encode the data at the compression ratio according to the third compression operation. Here, weights pretrained in the layers 1 to 4 may be fixed and the training may be performed. The training of the layer 1, the layer 2 and the layer 3 may be referred to as third stage training.

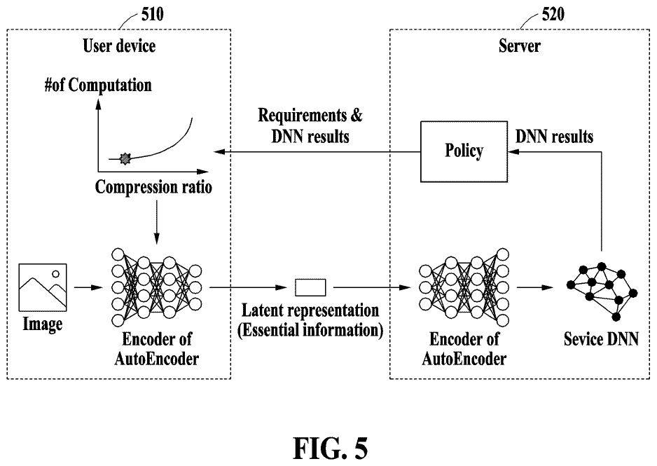

FIG. 5 is a diagram illustrating an operation of dynamically determining a compression level according to a wireless channel condition, according to an embodiment.

FIG. 5 illustrates an example case in which an encoding device and a decoding device includes encoding layers and decoding layers of three operations from the first compression operation to the third compression operation.

A user device 510 may determine the compression level, may encode data, and may transmit the encoded data to a server 520. The server 520 may be assumed to have high computation capability.

In order to ensure wireless channel fluctuations or application demand delay performance in the server 520, the server 520 may adjust the compression level at the user device 510 based on a service result.

In an example case in which the channel condition is sufficiently good that even relatively large data may be transmitted without a bottleneck, the server 520 with excellent computing power may sufficiently perform the remaining operations, and thus, an instruction may be transmitted to the user device 510 to lower the compression ratio. For example, in a case in which the channel condition is above a reference value, the server may perform the remaining operations and transmit an instruction to the user device 510 to perform operations to lower the compression ratio.

In an example case in which the channel condition is very bad and it is predicted that network transmission is to be delayed, an instruction may be transmitted to the user device 510 to perform as many operations as possible, that is, to increase the compression ratio. For example, in a case in which the channel condition is below a reference value, the server may predict that the network transmission is to be delayed, and transmit an instruction to the user device 510 to perform operations to increase the compression ratio.

Accordingly, the user device 510 may include a function of dynamically and differently adjusting the compression level according to a predefined compression level set in response to a signal transmitted from the server 520.

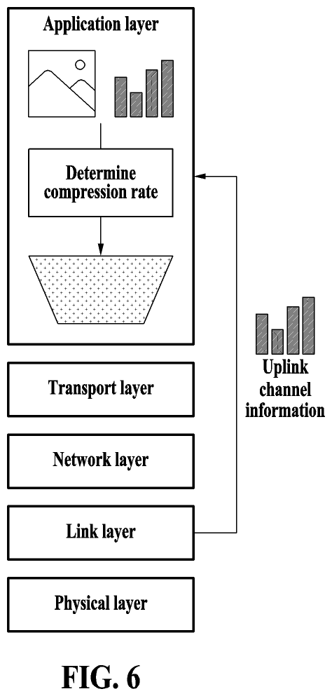

FIG. 6 is a diagram illustrating an operation of determining a compression level according to wireless channel condition estimation, according to an embodiment.

According to an embodiment, an encoding device is configured to adjust the compression level in proportion to compression time.

A real-time uplink channel condition may be estimated, and one of two operations may be performed accordingly. In an example case in which the uplink channel condition is good, the compression level may be lowered to transmit large data with a low compression ratio, and in an example case in which the uplink channel condition is bad, the compression level may be increased to reduce the size of the transmitted data.

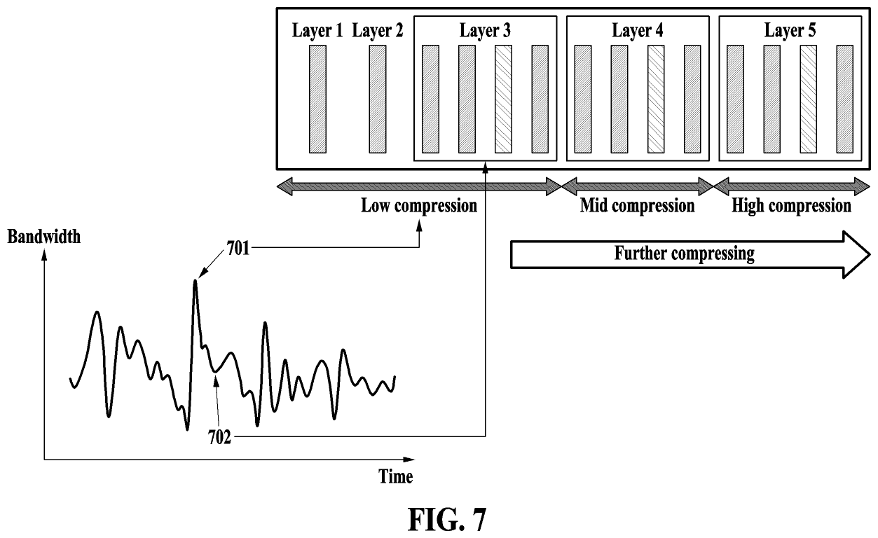

FIG. 7 is a diagram illustrating an operation of an encoding device according to a fluctuation in a channel condition, according to an embodiment.

According to an embodiment, from a time point 701 in which the encoding device starts compressing data, when the channel condition deteriorates rapidly, the data may be encoded at a high compression level by receiving, from a server, an instruction to pass the data through to a lower layer to increase the compression level to prevent a bottleneck, based on the channel condition.

In addition, with respect to a time point 702 in which the channel condition improves again, the data may be encoded at a low compression level by receiving, from a server, an instruction to decrease the compression level based on the improved channel condition, and data of large size may be transmitted.

As described above, by quickly and adaptively adjusting the compression level based on changing channel conditions, stability of data transmission may be improved and transmission delay or data loss may be minimized. For example, by quickly and adaptively adjusting the compression level in response to changing channel conditions, stability of data transmission may be improved and transmission delay or data loss may be minimized.

Since the compression level and corresponding compression time are predetermined in an encoding process, the amount of operations and a compression ratio may be adjusted at runtime.

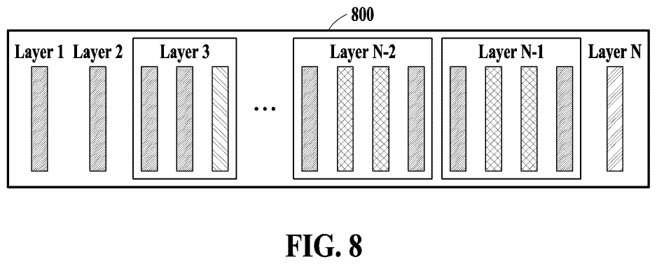

FIG. 8 is a diagram illustrating an encoding device having various layer structures, according to an embodiment.

As described above, a compression level may be defined in three operations according to an embodiment. However, the disclosure is not limited thereto, and as such, according to another embodiment, a larger set of compression levels may be configured by considering a structure of an encoding device used or requirements of an application.

For example, since the training method described above may be used regardless of a DNN structure of an encoding device, the training method may also be applied to an encoding device with lighter or more complex structures, considering computation capability of a user terminal.

In an example case in which the training method is utilized in other DNN structures as shown in FIG. 8, the encoding device may have various compression levels. For example, the DNN structures may include N levels, when N is an integer. For example, the layer 1 and the layer 2, which are corresponding adaptation modules, may be simply designed by only adjusting the size of an input feature map.

In addition, by increasing a layer depth of the encoding device in user terminals equipped with neural accelerators and the like, the performance may be utilized much more efficiently.

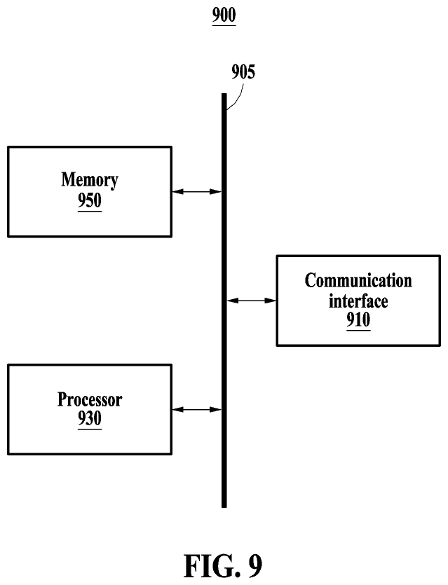

FIG. 9 is a block diagram illustrating a node of an encoding device, according to an embodiment.

Referring to FIG. 9, an encoding device 900 according to an embodiment may include a communication interface 910, a processor 930, and a memory 950. The communication interface 910, the processor 930, and the memory 950 may communicate with each other through a communication bus 905.

The communication interface 910 may transmit data or receive data. For example, the communication interface 910 may transmit or receive data wirelessly and/or in a wired manner. For example, the communication interface 910 may be implemented in the form of a wireless interface such as wireless fidelity (Wi-Fi), Bluetooth, Zigbee, and long range (LoRa), a wired interface such as Ethernet, universal serial bus (USB), or near-field communication (NFC). The communication interface 910 may receive data to be encoded.

The processor 930 may encode the data received through the communication interface 910. The processor 930 may dynamically determine a compression level to encode the data and may encode the data according to the compression level. For example, the compression level may be dynamically determined based on an upload communication environment such as a bit rate, requirements of a target application, or the size of the data.

The memory 950 may store a program for encoding by the processor 830 described above and a variety of information generated in an encoding process. In addition, the memory 950 may store a variety of data and programs. The memory 950 may include, for example, a volatile memory or a non-volatile memory. The memory 950 may include a high-capacity storage medium such as a hard disk to store a variety of data.

In addition, the processor 930 may perform at least one of the methods described with reference to FIGS. 1 to 8 or an algorithm corresponding to at least one of the methods. The processor 930 may be a data processing device implemented by hardware including a circuit having a physical structure to perform one or more operations. For example, the one or more operations may include code or instructions in a program. The processor 930 may be implemented as, for example, a central processing unit (CPU), a graphics processing unit (GPU), or a neural network processing unit (NPU). For example, the encoding device 900 that is implemented as hardware may include, for example, a microprocessor, a CPU, a processor core, a multi-core processor, a multiprocessor, an application-specific integrated circuit (A SIC), and a field-programmable gate array (FPGA).

The processor 930 may execute a program and may control the encoding device 900. Program code to be executed by the processor 930 may be stored in the memory 950.

According to an embodiment, a decoding device may include a communication interface, a processor, and a memory. The communication interface, the processor, and the memory may communicate with each other through a communication bus. According to an embodiment, the decoding device may be implemented by the same or similar component illustrated in FIG. 9, and as such, related description may be omitted.

The communication interface may receive data to be decoded. For example, the data may be received via wireless communication from a device such as a user terminal. According to an embodiment, the data received via wireless communication may be transmitted.

The processor may decode the data received through the communication interface. The processor may determine a decoding layer based on a compression level of dynamically determined data and may decode the data according to the compression level. For example, the compression level may be dynamically determined based on an upload communication environment such as a bit rate, requirements of a target application, or the size of the data.

The memory may store a program for decoding by the processor described above and various information generated during the decoding process. In addition, the memory may store a variety of data and programs. The memory may include, for example, a volatile memory or a non-volatile memory. The memory may include a high-capacity storage medium such as a hard disk to store a variety of data.

In addition, the processor of the decoding device may perform at least one of the methods described with reference to FIGS. 1 to 8 or an algorithm corresponding to at least one of the methods.

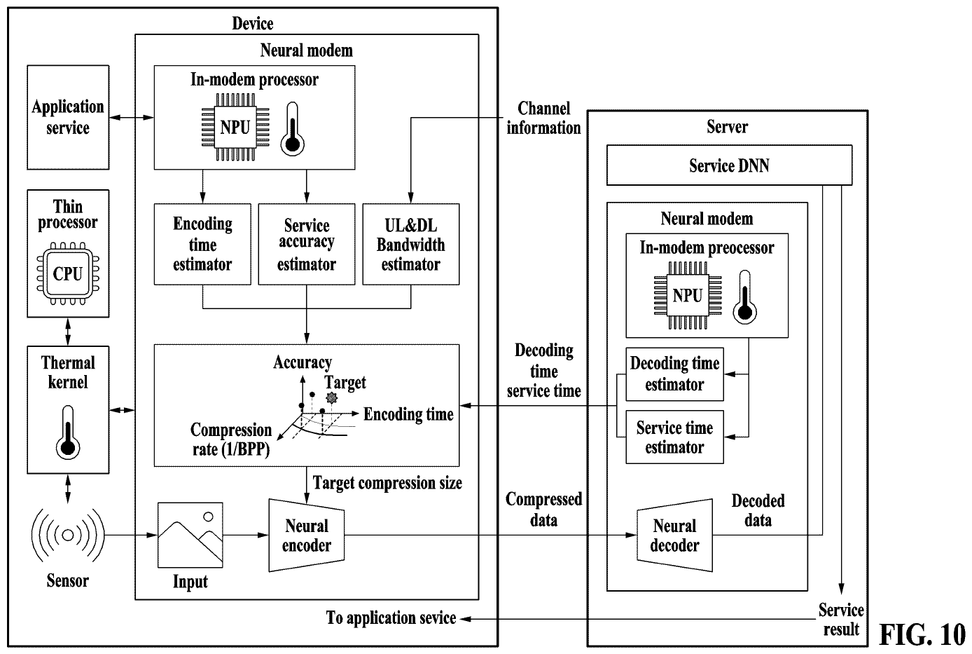

FIG. 10 is a diagram illustrating an example of a system according to an embodiment.

Through an encoding device and a decoding device, a compression ratio and the amount of operations may be dynamically adjusted according to one or more criteria. The one or more criteria may include, but is not limited to, the type of application, wireless channel conditions that change over time, etc.

Accordingly, a service that satisfies delay time required by the application may be provided while efficiently changing the compression ratio in such a system situation shown in FIG. 10.

Referring to FIG. 10, depending on the type of application, that is, depending on application demand performance or current channel information between an application service and an in-model processor, the compression level may be determined through an encoding time estimator, a service accuracy estimator, and an uplink (UL) & downlink (DL) bandwidth estimator.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or rearranged or supplemented by other components or their equivalents.

Therefore, other implementations, other embodiments, and equivalents to the claims are also within the scope of the following claims.

What is claimed is:

1. A data encoding method comprising:
receiving data;
determining a compression level corresponding to the data;
obtaining encoded data by encoding the data by an encoding layer corresponding to the determined compression level, among a plurality of encoding layers; and
outputting the encoded data.

2. The data encoding method of claim 1, wherein
the determining of the compression level of the data comprises at least one of:
determining the compression level based on a requirement of a target application of the data;
determining the compression level based on a communication environment of the data; or
determining the compression level based on a size of the data.

3. The data encoding method of claim 1, wherein
the encoding the data comprises, based on the determined compression level being a first compression level, encoding the data by a first encoding layer, among the plurality of encoding layers, corresponding to the first compression level.

4. The data encoding method of claim 1, wherein the encoding the data comprises:
based on the determined compression level being a second compression level:
encoding the data by a first encoding layer corresponding to a first compression level; and
sequentially encoding output data of the first encoding layer by a second encoding layer corresponding to the second compression level.

5. The data encoding method of claim 1, wherein
the encoding the data comprises extracting a feature map from the data by a convolution layer.

6. The data encoding method of claim 1, wherein
each of the plurality of encoding layers is trained to output a result for a target service in a decoding layer configured to decode the encoded data.

7. The data encoding method of claim 6, wherein
a first encoding layer corresponding to a first compression operation among the plurality of encoding layers and a first decoding layer corresponding to the first encoding layer are trained to obtain the result for the target service based on a first loss function.

8. The data encoding method of claim 7, wherein
a second encoding layer corresponding to a second compression operation among the plurality of encoding layers and a second decoding layer corresponding to the second encoding layer are trained to obtain the result for the target service based on a second loss function that fixes weights of the first encoding layer and the first decoding layer.

9. A data decoding method comprising:
receiving data;
receiving a compression level of the data;
obtaining decoded data by decoding the data by a decoding layer corresponding to the compression level, among a plurality of decoding layers; and
outputting the decoded data.

10. The data decoding method of claim 9, wherein
the compression level of the data is dynamically determined based on at least one of:
requirements of a target application of the data;
a communication environment of the data; or
a size of the data.

11. The data decoding method of claim 9, wherein
the decoding of the data comprises, based on the compression level being a first compression level, decoding the data by a first decoding layer, among the plurality of decoding layers, corresponding to the first compression level.

12. The data decoding method of claim 9, wherein the decoding the data comprises:
based on the compression level being a second compression level:
decoding the data by a second decoding layer corresponding to the second compression level; and
sequentially decoding output data of the second decoding layer by a first decoding layer corresponding to a first compression level.

13. The data decoding method of claim 9, wherein
the decoded data comprises a result for a target service corresponding to the data.

14. The data decoding method of claim 9, wherein
each of the plurality of decoding layers is trained to output a result for a target service.

15. The data decoding method of claim 14, wherein
a first decoding layer corresponding to a first compression operation among the plurality of decoding layers and a first encoding layer corresponding to the first decoding layer are trained to obtain the result for the target service based on a first loss function, and
a second decoding layer corresponding to a second compression operation among the plurality of decoding layers and a second encoding layer corresponding to the second decoding layer are trained to obtain the result for the target service based on a second loss function that fixes weights of the first encoding layer and the first decoding layer.

16. An encoding device comprising:
at least one processor; and
a memory configured to store instructions,
wherein, when executed by the at least one processor, the instructions are configured to cause the encoding device to:
receive data;
determine a compression level corresponding to the data;
obtain encoded data by encoding the data by an encoding layer corresponding to the compression level, among a plurality of encoding layers; and
output the encoded data.

17. The encoding device of claim 16, wherein
the determining of the compression level of the data comprises at least one of:
determining the compression level based on requirements of a target application of the data;
determining the compression level based on a communication environment of the data; or
determining the compression level based on a size of the data.

18. The encoding device of claim 16, wherein
the encoding the data comprises, based on the determined compression level being a first compression level, encoding the data by a first encoding layer, among the plurality of encoding layers, corresponding to the first compression level.

19. The encoding device of claim 18, wherein the encoding of the data comprises:
based on the determined compression level is a second compression level:
encoding the data by the first encoding layer corresponding to the first compression level; and
sequentially encoding output data of the first encoding layer by a second encoding layer corresponding to the second compression level.
